(19) United States
(12) Patent Application Publication
(10) Pub. No.: US 2026/0037731 A1
(43) Pub. Date: Feb. 5, 2026

(54) MACHINE LEARNING BASED APPROACH FOR AUTOMATICALLY IDENTIFYING AND EXTRACTING TRANSACTIONS FROM WEBPAGES

(71) Applicant: INTUIT INC., Mountain View, CA (US)

(72) Inventors: Aleksandr KIM, Tel Aviv (IL); Yair HORESH, Kfar-Saba (IL); Itay MARGOLIN, Petah Tikva (IL)

(21) Appl. No.: 18/789,839

(22) Filed: Jul. 31, 2024

(51) Int. Cl. G06F 40/295; G06F 40/242

(52) U.S. Cl. CPC G06F 40/295; G06F 40/242

(57) ABSTRACT

A method for training a machine learning model to automatically identify and extract transactions from webpages includes: obtaining sample data from a webpage, the sample data including: (i) a plurality of live transactions; and (ii) a first set of labels, each label in the first set of labels corresponding to a respective attribute of a plurality of different attributes of each of the plurality of live transactions; generating training data based on the sample data, the training data comprising: (i) a plurality of synthetic transactions; and (ii) a second set of labels including one or more labels that differ from each label included in the first set of labels; and training the machine learning model to automatically identify and extract transactions from webpages using the training data.

### INTRODUCTION

Aspects of the present disclosure are directed to machine learning techniques for automatically identifying and extracting transactions from webpages.

### BACKGROUND

A provider (e.g., a bank) may support a website that clients of the provider may access to view their unique log of transactions (e.g., financial transactions). For a given client, the website may include a webpage (e.g., a hypertext markup language webpage) displaying a unique log of transactions involving the given client over a period of time (e.g., the last 30 days). For example, the webpage may include a transactions table having multiple rows and multiple columns, with each row representing a different transaction involving the client and each column representing a different entity (e.g., date, balance, description) of each of the transactions involving the client.

A software application may be used to periodically (e.g., once a day) extract recent transactions involving its users. For example, to collect the recent transactions for a given user of the software application, the software application communicates with a website supported by a provider (e.g., bank) for the given user. In doing so, the software application may identify and extract recent transactions involving the user from the website. Since the design and structure of websites vary amongst the different providers (e.g., banks), the software application supports a unique script (e.g., computer executable instructions associated with identifying transactions) for each provider. The script is manually generated and is updated (e.g., also manually) each time the respective provider makes changes (e.g., to the design of the website, to passes for transactions to be extracted) to the website. However, given the large number (e.g., in the thousands) of providers, manually creating and updating unique scripts for every provider is not feasible.

Accordingly, a need exists for improved techniques for identifying and extracting transactions from webpages.

### BRIEF SUMMARY

Certain embodiments provide a method for training a machine learning model to automatically identify and extract transactions from webpages. The method generally includes: obtaining sample data from a webpage, the sample data including: (i) a plurality of live transactions; and (ii) a first set of labels, each label in the first set of labels corresponding to a respective attribute of a plurality of different attributes of each of the plurality of live transactions; generating training data based on the sample data, the training data comprising: (i) a plurality of synthetic transactions; and (ii) a second set of labels including one or more labels that differ from each label included in the first set of labels; and training the machine learning model to automatically identify and extract transactions from webpages using the training data.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a document including a transactions table according to some aspects of the present disclosure.

FIG. 2 depicts an example system for automatically identifying transactions for extraction on webpages according to some aspects of the present disclosure.

FIG. 3A depicts a transactions table populated with real transactions according to some aspects of the present disclosure.

FIG. 3B depicts training data for training a named entity recognition model to automatically identify transactions for extraction on webpages according to some aspects of the present disclosure.

FIG. 4 depicts a method for training a machine learning model to automatically identify and extract transactions from webpages according to some aspects of the present disclosure.

FIG. 5 depicts a method for automatically identifying and extracting transactions from a webpage according to some aspects of the present disclosure.

FIG. 6 depicts an example processing system according to some embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training a machine learning model to automatically identify transactions for extraction on different webpages.

Example aspects of the present disclosure are directed to a machine learning based approach for automatically identifying and extracting transactions from webpages, such as webpages supported by different providers (e.g., banks). The disclosed machine learning based approach uses a small set of sample transactions (e.g., live transactions obtained from one or more live webpages) to generate a large set of training data for training a machine learning model (e.g., using a natural language processing algorithm, such as named entity recognition) to automatically identify and extract transactions from webpages having various designs and structures.

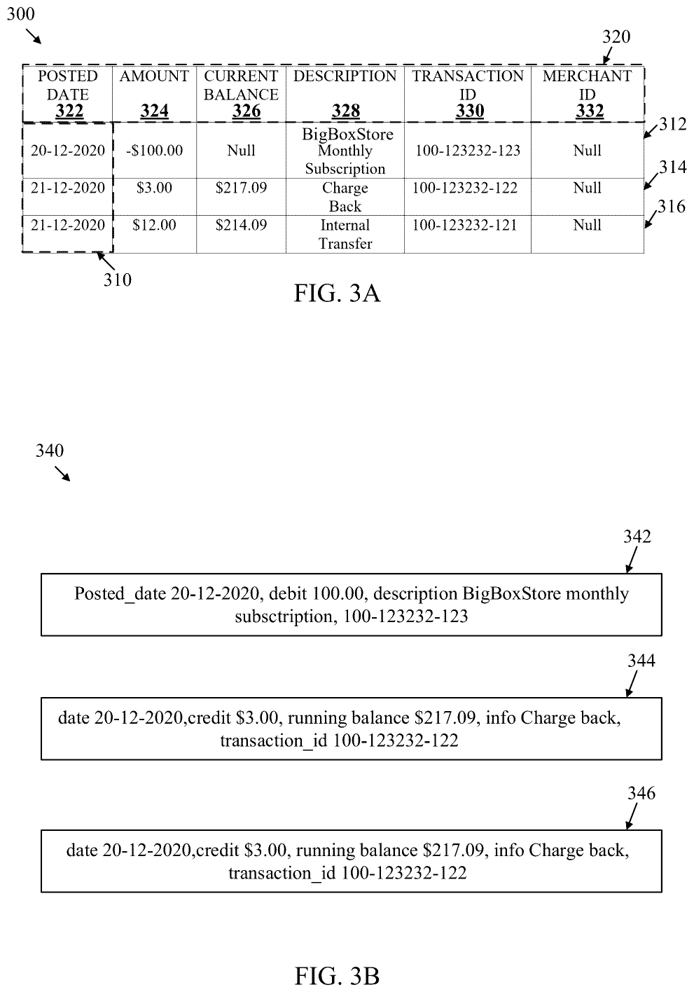

The small set of sample transactions may be included in a transactions table that is representative of the structure (e.g., a table) in which transactions are typically displayed on different webpages, with each webpage being supported by a different provider (e.g., bank). More specifically, as illustrated below in FIG. 3A, the transactions table includes a plurality of rows and a plurality of columns, with each row of the transactions table corresponding to a different sample transaction and each column of the transactions table corresponding to a different attribute (e.g., attribute) of the sample transactions. The transactions table further includes a different label (e.g., name) for each of the different attributes of the sample transactions. For example, a first attribute of the sample transactions that is included in a first column of the transactions table having only numbers with a monetary format (e.g., numbers separated by a decimal point, such as #. ##) may be labeled “amount”. As another example, a second attribute of the sample transactions that is included in a second column of the transactions table having only numbers with a date format (e.g., MM-DD-YYYY) may be labeled “date”.

However, the format of the transactions table may vary amongst the providers. More specifically, providers may use different labels for the same attribute of transactions. For example, a first provider (e.g., Bank A) supporting a webpage displaying a transactions table populated with transactions may use the label “debit/credit” for the first attribute of the transactions in the transactions table instead of “amount” like in the transactions table including the small set of sample transactions. As another example, a second provider (e.g., Bank B) supporting a webpage displaying a transactions table populated with transactions may use the label “chargeable” for the first attribute of the transactions in the transactions table instead of “amount” like in the transactions table including the small set of sample transactions.

The notation used for the first attribute of transactions may also vary amongst the different providers (e.g., banks). For example, the first provider (e.g., Bank A) supporting the first webpage may include one operand (e.g., minus sign) for the first attribute of transactions that are withdrawals and a different operand (e.g., plus sign) for the first attribute of transactions that are credits, whereas the second provider (e.g., Bank B) supporting the second webpage may only use an operand (e.g., minus sign or plus sign) for the first attribute of transactions that are credits.

To account for the different labels providers (e.g., banks) use for the same attribute of transactions, the disclosed machine learning based approach includes generating a dictionary of alternate labels for each of the different attributes of the small set of sample transactions. For example, the dictionary may include alternate labels for the label “amount” that is used for the first attribute of each of the sample transactions. Examples of alternate labels for “amount” may include labels other providers use for the same attribute, such as “debit/credit” or “chargeable” as described above. As another example, the dictionary may include alternate labels for the label “date” that is used for a second attribute of the sample transactions. Examples of alternate labels for “date” may include labels other providers use for the same attribute, such as “posted date” and “transaction date”.

The disclosed machine learning based approach may use the dictionary to create the large training dataset for training the machine learning model. For example, multiple synthetic transactions may be created from the small set of sample transactions by replacing the label for the different attributes of the sample transactions with alternate labels included in the dictionary. As used herein, the term “synthetic transaction” refers to a transaction generated programmatically to mimic the statistical properties and patterns of live transactions. As an example, the label “date” that is used for one attribute of the sample transactions may be swapped with alternate labels for “date” in the dictionary to generate multiple synthetic transactions. For instance, a first synthetic transaction may be created by replacing “date” with “posted date”; a second synthetic transaction may be created by replacing “date” with “transaction date”; and a third synthetic transaction may be created by replacing “date” with “payment date.” In this manner, the disclosed machine learning based approach creates the large set of training data by creating multiple synthetic transactions from the small set of sample transactions (that is, real transactions) that are representative of the distribution of different labels used by the providers for the same attribute (e.g., attribute) of transactions.

In some embodiments, the machine learning model may be pre-trained using the large set of training data and, once the pre-training is complete, may be trained (e.g., fine-tuned) based on identifying and automatically extracting transactions from different webpages, with each of the different webpages supported by a different provider (e.g., bank). In this manner, the machine learning model may be adjusted to real-world data.

Example aspects of the present disclosure provide numerous technical effects and benefits. For example, by creating a large training dataset of synthetic transactions from a small set of live transactions, the disclosed machine learning based approach does not require storing entire webpages that, in addition to live transactions, include sensitive information (e.g., account name, date of birth, social security number) that present security and privacy issues. In this manner, the disclosed machine learning based approach preserves the privacy of such sensitive information. Furthermore, the disclosed machine learning based approach may be used to extract transactions from webpages having various designs and structures and thus, in contrast to conventional techniques for extracting transactions from webpages, does not include a unique script for all the different providers supporting websites from which transactions are extracted. In this manner, the functionality of computing devices implementing the disclosed machine learning based approach may be improved compared to the functionality of computing devices implementing conventional approaches requiring a unique script for each provider. More specifically, the memory of the computing devices may be improved since the machine learning based approach does not include a plurality of unique scripts for each provider. Software development may also be simplified by avoiding generation of unique scripts for each provider. Additionally, the machine learning based approach described herein is more easily updated, and is more dynamic than fixed unique scripts for each provider, allowing for extraction of a broader array of transactions and enabling efficient re-training for improved performance over time (e.g., as opposed to manually updating multiple unique scripts).

Furthermore, by generating alternate labels, such as synonyms, for one or more attributes of the synthetic transactions, the disclosed machine learning approach provides a more diverse set of training data. In this manner, the performance (e.g,., accuracy) of the machine learning model is improved, as the machine learning model may detect transactions having labels that, in some instances, are syntactically and/or semantically different (e.g., not an exact match) from the labels used for the attributes of the sample transactions that are used to generate the training data.

### Example Webpage Including Transactions

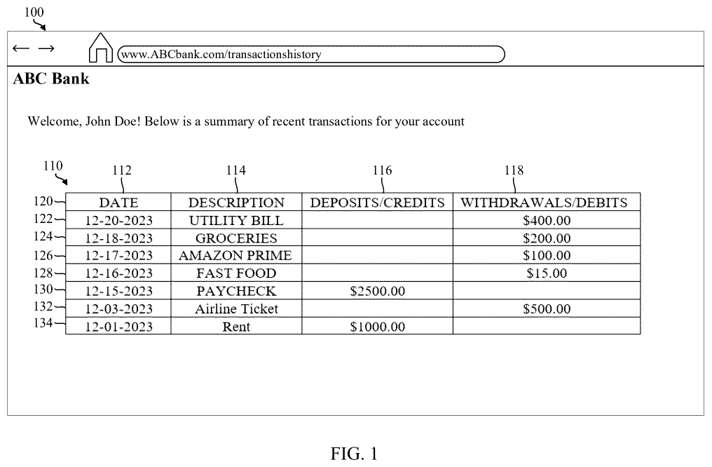

FIG. 1 depicts a webpage 100 according to some embodiments of the present disclosure. The webpage 100 may be supported by a provider (e.g., ABC Bank) and includes multiple transactions involving a user (e.g., John Doe) associated with the provider. As illustrated, in some embodiments, the webpage 100 may include a table 110 populated with the multiple transactions involving the user.

The table 110 includes a plurality of columns, with each of the plurality of columns corresponding to a different attribute of the recent transactions. For example, a first column 112 of the table 110 corresponds to a first attribute (e.g., named “date”) of the recent transactions, a second column 114 of the table 110 corresponds to a second attribute (e.g., named “description”) of the recent transactions, a third column 116 of the table 110 corresponds to a third attribute (e.g., named “deposit/credits”) of the recent transactions, and a fourth column 118 of the table 110 corresponds to a fourth attribute (e.g., named “withdrawals/debits”) of the recent transactions. Although the table 110 is illustrated as having four columns, in other embodiments, the table 110 may include more or fewer columns.

The transactions table 110 includes a plurality of rows, with each of the plurality of rows corresponding to a different recent transaction involving the user. The table 110 includes an initial row 120, with each cell in the initial row 120 populated with the names of the different attributes of the recent transactions. For example, a first cell may be populated with the name (e.g., date) of the first attribute, a second cell may be populated with the name (e.g, description), a third cell may be populated with the name (e.g., deposits/credits) of the third attribute, and a fourth cell may be populated with the name (e.g., withdrawals/debits) of the fourth attribute.

The table 110 may include rows 122, 124, 126, 128, 130, 132, 134 following the initial row 120, with each of the rows 122, 124, 126, 128, 130, 132, 134 corresponding to a different financial transaction involving the user. For example, row 122 may correspond to a first transaction occurring on Dec. 20, 2023 in which $400 were withdrawn from the customer's account (e.g., checking, savings) to pay an expense (e.g., utility bill). As another example, row 128 may correspond to a second transaction occurring on Dec. 15, 2023 in which the customer's employer deposited $2500 in the customer's account.

A software application may be used to extract the transactions from the webpage 100. For example, the provider (e.g., ABC bank) supporting the webpage 100 may implement an application programming interface (API) that allows the software application to communicate with the webpage 100 to extract the recent transactions involving the user (e.g., John Doe). However, a different webpage (e.g., supported by a different provider, such as EDF bank) may not implement such an API. Given these differences, an existing software application may support unique scripts for each of the different webpages from which the software application extracts data (e.g., transactions). As mentioned above, the unique scripts are manually generated and manually updated each time changes are made to the webpages.

### Example System for Automatically Identifying Transactions for Extraction on Webpages

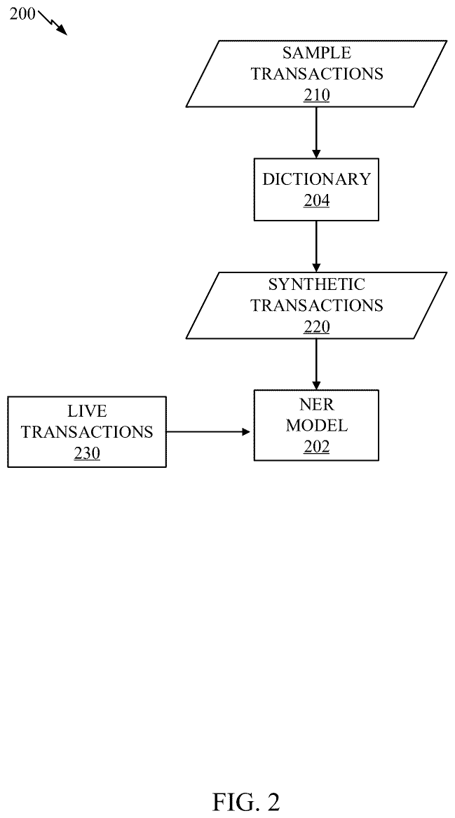

FIG. 2 depicts a system 200 for automatically extracting transactions from webpages according to some embodiments of the present disclosure.

The system 200 includes a named entity recognition (NER) model 202. The NER model 202 generally represents a machine learning model that is trained to output names of entities that are indicated in text that is input to the machine learning model. In one example implementation, the NER model 202 is built based on a Bidirectional Encoder Representations from Transformers (BERT) model, which involves the use of masked language modeling to determine text embeddings. In one embodiment, the NER model 202 includes such a BERT model (or, more generally, an embedding model of some sort), and uses the BERT model to generate embeddings of input text for use in determining named entities that are indicated in the text. The BERT model may, for example, be pre-trained before being used to generate the NER model 202, and may be further trained or fine-tuned as part of the training of the NER model 202 based on training data specific to the intended purpose of the NER model 202 (e.g. identification of transactions in different webpages). References to training herein may also refer to fine-tuning of a model that has already been trained. For instance, training inputs representing text strings may be provided to the NER model 202, and outputs produced by the NER model 202 in response to the training inputs (e.g., indicating named entities, such as labels of different attributes transactions that are present in the text strings) may be compared to known labels associated with the training inputs (e.g., based on user-provided labels indicating names of entities indicated in transactions that are present in the text strings). Parameters of the NER model 202, including parameters of the BERT model or other type of embedding model, may be iteratively adjusted based on the comparing such that the BERT model is optimized along with the rest of NER model 202 for accuracy of the final output of NER model 202. It is noted that a BERT model is included as an example, and other types of machine learning models may also be used. In one example, the NER model 202 includes an embedding model such as a BERT model as well as one or more additional layers, such as fully-connected layers and/or aggregation layers. In other embodiments, the NER model 202 does not include an embedding model.

In some embodiments, the system 200 includes a dictionary 204 that uses sample data 210 to generate training data 212 for training the NER model 202. The sample data 210 may include live transactions from one or more live websites supported by one or more providers (e.g., banks). The sample data 210 may also include labels for each of the plurality of different attributes of the live transactions. In some embodiments, as illustrated in FIG. 3A, the sample data 210 may include a transactions table populated with the live transactions and the labels for each of the different attributes of the live transactions.

The dictionary 204 may be populated with different labels for each of the plurality of different attributes of transactions that may be included in a transaction table displayed on a webpage supported by a provider (e.g., a bank), such as the transaction table 110 displayed on the webpage 100 discussed above with reference to FIG. 1. For example, the dictionary 204 may include alternate labels for each of the different labels included in the sample data 210. In some embodiments, the alternate labels may be labels used by other providers (e.g., banks) for the same attribute. In alternative embodiments, the alternate labels may include one or more synonyms for each of the different labels included in the sample data 210.

The system 200 may use the sample data 210 to generate training data for training the NER model 202 to automatically identify and extract transactions on webpages. For example, as illustrated in FIG. 3B, multiple synthetic transactions may be created from the real transactions included in the sample data 210 by replacing the label for the different attributes of the real transactions included in the sample data 210 with alternate labels included in the dictionary 204.

In some embodiments, one or more of the real transactions included in the sample data 210 may, for one of the attributes, include an operand, such as a minus sign or a plus sign. For example, the attribute may be an amount of money credited or withdrawn from an account (e.g., checking, savings) for a given user and the plus sign may be used to indicate transactions that are credits (that is, money being deposited in the account) and a negative sign may be used to indicate transactions that are withdrawals (that is, money being withdrawn from the account). In some embodiments, the first attribute of the one or more synthetic transactions may or may not include the operand. For example, a popular approach across the different providers (e.g., banks) may be to not include the minus sign for withdrawals and the synthetic transactions may conform to the popular approach.

In other embodiments, the real transactions included in the sample data 210 may not include the operand and the popular approach amongst the different providers may be to include the plus sign for transactions indicative of a credit to the account for the given user. In such embodiments, the synthetic transactions that are indicative of credits to such accounts may include the plus sign to conform to the popular approach.

In some embodiments, after the NER model 202 has been trained using the synthetic transactions 220, the NER model 202 may be fine-tuned using live transactions 230 from one or more webpages. For example, the NER model 202 may be used to extract live transactions from one or more webpages, the extracted transactions may be reviewed (e.g., by an expert), and training data may be generated based on whether the extracted transactions are confirmed to be accurate or inaccurate. Such training data may be used through a training process such as that described above to fine-tune or re-train NER model 202 for improved performance. In this manner, the NER model 202 may be fine-tuned to automatically identify and extract transactions from different webpages.

### Examples of Real Transactions and Synthetic Transactions

FIG. 3A illustrates an example of sample data according to some embodiments of the present disclosure. For example, the sample data of FIG. 3A may be used as sample data 210 in the system 200 discussed above with reference to FIG. 2.

As illustrated, the sample data may include a transactions table 300 populated with real transactions from one or more webpages. More specifically, the transactions table 300 includes multiple rows 310 and multiple columns 320, with each of the rows 310 corresponding to a different real transaction and each of the columns 320 corresponding to a different attribute of the real transactions.

The rows 310 of the transaction table 300 include a first row 312 populated with a first transaction, a second row 314 populated with a second transaction, and a third row 316 populated with a third transaction. In some embodiments, the transactions table 300 may include more or fewer real transactions. Furthermore, in some embodiments, all of the real transactions (e.g., first transaction 302, second transaction 304, and third transaction 306) may be from the same webpage. In alternative embodiments, the real transactions may be from different webpages supported by different providers (e.g., banks). For example, in such embodiments, the first transaction 302 may be from a first webpage supported by a first provider (e.g., Bank A), the second transaction 304 may be from a second webpage supported by a second provider (e.g., Bank B), and the third transaction 306 may be from a third provider (e.g., Bank C).

The columns 320 of the transaction table 300 include a first column 322 corresponding to a first attribute of the real transactions, a second column 324 corresponding to a second attribute of the real transactions, a third column 326 corresponding to a third attribute of the real transactions, a fourth column 328 corresponding to a fourth attribute of the real transactions, a fifth column 330 corresponding to a fifth attribute of the real transactions, and a sixth column 332 corresponding to a sixth attribute of the real transactions. In other embodiments, the transactions table 300 may include more or fewer columns.

As illustrated, the transactions table 300 may include a label (e.g., text) identifying each of the different attributes of the real transactions. For instance, the transactions table 300 includes the label “POSTED DATE” for the first attribute of the real transactions, the label “AMOUNT” for the second attribute of the real transactions, the label “CURRENT BALANCE” for the third attribute of the real transactions, the label “DESCRIPTION” for the fourth attribute of the real transactions, the label “TRANSACTION ID” for the fifth attribute of the real transactions, and the label “MERCHANT” for the sixth attribute of the real transactions. Such labels may be included in column headers in transactions table 300.

It should be understood that the value “NULL” included in one or more cells of the transaction table 300 indicates that a particular transaction does not include a value for that particular attribute. For example, the first transaction populating the first row 312 of the transactions table 300 includes the NULL value for the third attribute (e.g., labeled “CURRENT BALANCE”) of the transactions. Similarly, each of the transactions include the NULL value for the sixth attribute (e.g., labeled “MERCHANT ID”) of the transactions.

FIG. 3B illustrates synthetic transactions 340 generated using sample data that includes real transactions according to some embodiments of the present disclosure. For example, the synthetic transactions 340 may be generated using the real transactions included in the transactions table 300 discussed above with reference to FIG. 3A.

The synthetic transactions 340 include a first synthetic transaction 342 generated using the first transaction populating the first row 312 of the transactions table 300. As illustrated, the first synthetic transaction 342 includes the same label (e.g., “Posted Date” and “Description”) for the first and third attributes of the transactions table 300. However, the first synthetic transaction 342 does not include the label (e.g., “Amount”) for the second attribute. Instead, the first synthetic transaction 342 uses a different label, “Debit”, for the second attribute. Also, the first synthetic transaction 342 does not include the operand (e.g., minus sign) associated with the value (e.g., $100) of the second attribute for the first transaction. Finally, the first synthetic transaction 342 does not include the label (e.g., “Transaction ID”) for the fifth attribute and excludes the sixth attribute (e.g., labeled “Merchant ID”) entirely since the first transaction includes the NULL value for the sixth attribute.

The synthetic transactions 340 include a second synthetic transaction 344 generated using the second transaction populating the second row 314 of the transactions table 300. As illustrated, the second synthetic transaction 344 uses different labels for each of the first four attributes of the real transactions included in the transactions table 300. For example, instead of using “posted date”, “amount”, “current balance”, and “description” like in the transactions table 300, the second synthetic transaction 344 uses “date”, “credit”, “running balance”, and “info”, respectively. Also, like the first synthetic transaction 342, the second synthetic transaction 344 excludes the sixth attribute (e.g., labeled “Merchant ID”) entirely since the second transaction includes the NULL value for thte sixth attribute.

The synthetic transactions 340 include a third synthetic transaction 346 generated using the third transaction populating the third row 316 in the transactions table 300. As illustrated, the third synthetic transaction 346 uses different labels for each of the first four attributes of the real transactions included in the transactions table 300. For example, instead of using “posted date”, “amount”, “current balance”, and “description” as in the transactions table 300, the third synthetic transaction 346 uses “date”, “credit”, “running balance”, and “info”, respectively. Also, like the first synthetic transaction 342 and second synthetic transaction 344, the third synthetic transaction 346 excludes the sixth attribute (e.g., labeled “Merchant ID” in transactions table 300) entirely since the third transaction in the transactions table 300 does not include a merchant identification.

It should be appreciated that each of the synthetic transactions 340 depicted in FIG. 3B may be generated using the dictionary 204 discussed above with reference to FIG. 2. Also, as illustrated, each of the plurality of synthetic transactions 340 may be formatted as a string of text (e.g., hypertext markup language visible text). For example, the string of text may include the different labels for each of the different attributes of the synthetic transactions. Additionally, for each of the synthetic transactions, the value for each of the different attributes may be concatenated to the respective label of the plurality of different labels as illustrated. In this manner, the synthetic transactions may be in a format needed to train a machine learning model, such as the named entity recognition model 202 of FIG. 2, to automatically identify and extract transactions from webpages.

Example Operations for Training a Machine Learning Model to Automatically Identify and Extract Transactions from Webpages

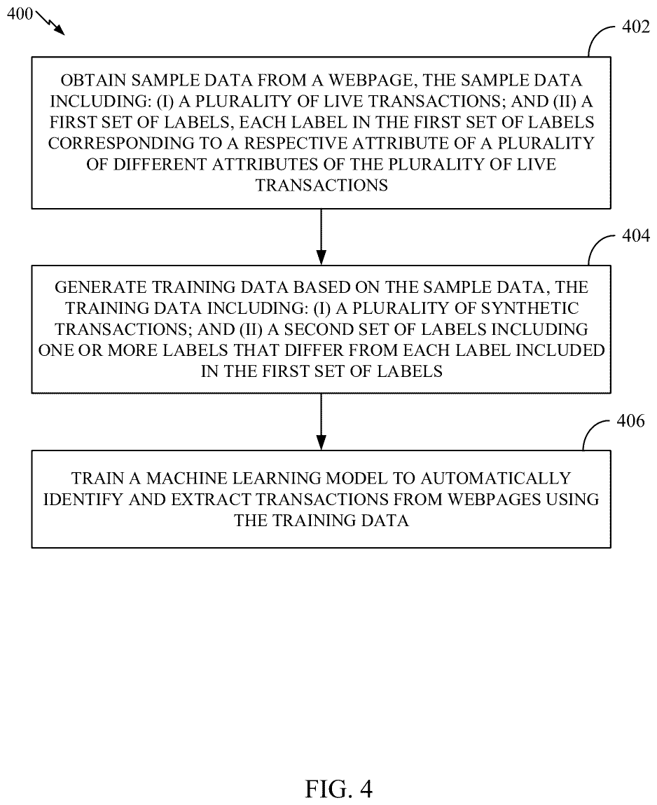

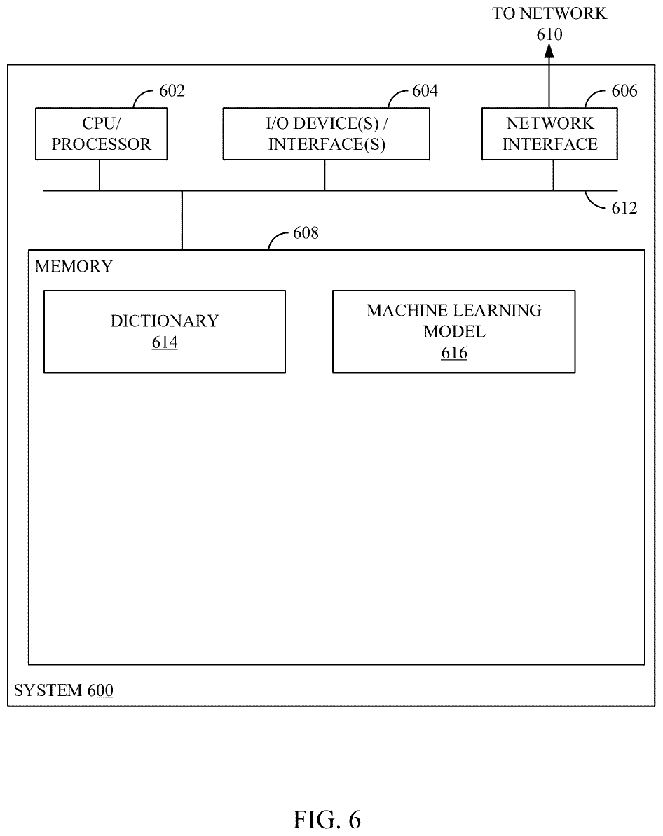

FIG. 4 is a flow diagram of example operations 400 for training a machine learning model to automatically identify and extract transactions from webpages according to some embodiments of the present disclosure. The operations 400 may be performed by instructions executing on a computing system, such as the computing system discussed below with reference to FIG. 6.

Operation 402 includes obtaining sample data from one or more webpages. For example, in some embodiments, the sample data may include a transactions table, such as the transactions table illustrated in FIG. 3A, having multiple rows and multiple columns, with each of the rows corresponding to a different live transaction from the webpage(s) and each of the columns corresponding to a respective attribute of a plurality of different attributes of each of the plurality of live transactions. The sample data further includes a first set of labels, with each label included in the first set of labels corresponding to a respective attribute of the plurality of different attributes of the live transactions.

Operation 404 includes generating training data based on the sample data. For example, in some embodiments, the training data may include synthetic transactions, such as the synthetic transactions illustrated in FIG. 3B, generated from the plurality of live transactions included in the sample data obtained at operation 402. The training data may further include a second set of labels including one or more labels that are different from each of the labels in the first set of labels included in the sample data obtained at operation 402.

Operation 406 includes training the machine learning model to automatically identify and extract transactions from webpages using the training data. For instance, the machine learning model may be trained in the manner described above with reference to training the NER model 202 to automatically identify and extract transactions from webpages.

Example Operations for Automatically Identifying and Extracting Transactions from Webpages using a Trained Machine Learning Model

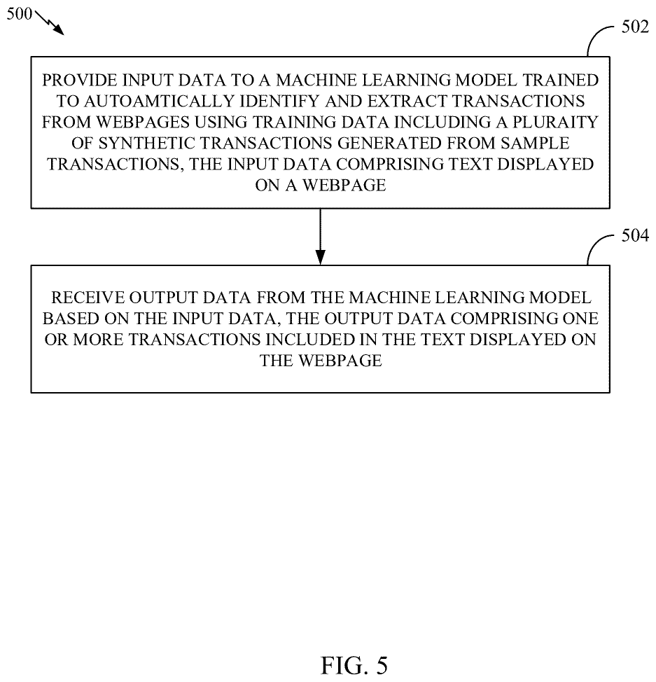

FIG. 5 is a flow diagram of example operations 500 for training a machine learning model to automatically identify and extract transactions from webpages according to some embodiments of the present disclosure. The operations 500 may be performed by instructions executing on a computing system, such as the computing system discussed below with reference to FIG. 6.

Operation 502 includes providing input data to a machine learning model, such as the NER model 202 discussed above with reference to FIG. 2, trained to automatically identify and extract transactions from webpages using training data including a plurality of synthetic transactions generated from sample transactions, the input data comprising text displayed on a webpage, such as the webpage 100 illustrated in FIG. 1.

Operation 504 includes receiving output data from the machine learning model based on the input data. For instance, in some embodiments, the output data includes one or more transactions included in the text displayed on the webpage. For example, the machine learning model may be a named entity recognition model trained to identify the transactions included in the text based on labels that are included in the text and indicative of different attributes of the transactions.

### Example Computing System

FIG. 6 illustrates an example computing system 600 with which embodiments of the disclosure related to automatically recommending navigation actions within a user interface of an application may be implemented.

The computing system 600 includes a central processing unit (CPU) 602, one or more I/O device interfaces 604 that may allow for the connection of various I/O devices 604 (e.g., keyboards, displays, mouse devices, pen input, etc.) to the computing system 600, a network interface 606, a memory 608, and an interconnect 612. It is contemplated that one or more components of the computing system 600 may be located remotely and accessed via a network 610. It is further contemplated that one or more components of the computing system 600 may include physical components or virtualized components.

The CPU 602 may retrieve and execute programming instructions stored in the memory 608. Similarly, the CPU 602 may retrieve and store application data residing in the memory 608. The interconnect 612 transmits programming instructions and application data, among the CPU 602, the I/O device interface 604, the network interface 606, the memory 608. The CPU 602 is included to be representative of a single CPU, multiple CPUs, a single CPU having multiple processing cores, and other arrangements.

Additionally, the memory 608 is included to be representative of a random access memory or the like. In some embodiments, the memory 608 may include a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, the memory 608 includes a dictionary 614 and a machine learning model 616, which may be representative of dictionary 204 and named entity recognition model 202 of FIG. 2.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for training a machine learning model to automatically identify and extract transactions from webpages, the method comprising:
obtaining sample data from a webpage, the sample data including: (i) a plurality of live transactions; and (ii) a first set of labels, each label in the first set of labels corresponding to a respective attribute of a plurality of different attributes of each of the plurality of live transactions;
generating training data based on the sample data, the training data comprising: (i) a plurality of synthetic transactions; and (ii) a second set of labels including one or more labels that differ from each label included in the first set of labels; and
training the machine learning model to automatically identify and extract transactions from webpages using the training data.

2. The method of claim 1, wherein generating the training data comprises:
generating a dictionary including one or more alternate labels for each respective label in the first set of labels; and
replacing one or more respective labels included in the first set of labels with an alternate label for the one or respective labels in the dictionary to generate the plurality of synthetic transactions.

3. The method of claim 2, wherein the one or more alternate labels for each respective label in the first set of labels comprises one or more synonyms of the respective label.

4. The method of claim 2, wherein the one or more alternate labels for each respective label in the first set of labels comprise a label for each respective label on a different webpage than the webpage from which the sample data is obtained.

5. The method of claim 2, wherein the replacing comprises randomly replacing the one or more respective labels included in the first set of labels with the alternate label for the one or more respective labels in the dictionary.

6. The method of claim 2, wherein:
the first attribute of one or more of the plurality of live transactions has a monetary format; and
generating the training data comprises adding an operand for the first attribute of one or more of the synthetic transactions.

7. The method of claim 1, further comprising:
subsequent to training the machine learning model using the training data, fine-tuning the trained machine learning model based on using the machine learning model to automatically extract transactions from a webpage other than the webpage from which the sample data is obtained.

8. The method of claim 1, wherein the machine learning model comprises a named entity recognition model.

9. A method for automatically identifying and extracting transactions from webpages, comprising:
providing input data to a machine learning model trained to automatically identify and extract transactions from webpages using training data including a plurality of synthetic transactions generated from sample transactions, the input data comprising text displayed on a webpage; and
receiving output data from the machine learning model based on the input data, the output data comprising one or more transactions included in the text displayed on the webpage.

10. The method of claim 9, wherein the machine learning model comprises a named entity recognition model.

11. The method of claim 9, wherein the input data comprises a transactions table including the text, the transactions table including multiple rows and multiple columns, each of the rows including a different transaction of a plurality of transactions and each of the rows corresponding to a respective attribute of a plurality of different attributes of the plurality of transactions.

12. A system for training a machine learning model to automatically identify and extract transactions from webpages, the system comprising:
a memory including computer executable instructions; and
a processor configured to execute the computer executable instructions and cause the system to:
obtain sample data from a webpage, the sample data including: (i) a plurality of live transactions; and (ii) a first set of labels, each label in the first set of labels corresponding to a respective attribute of a plurality of different attributes of each of the plurality of live transactions;
generate training data based on the sample data, the training data comprising: (i) a plurality of synthetic transactions; and (ii) a second set of labels including one or more labels that differ from each label included in the first set of labels; and
train the machine learning model to automatically identify and extract transactions from webpages using the training data.

13. The system of claim 12, wherein to generate the training data, the computer executable instructions cause the system to:
generate a dictionary including one or more alternate labels for each respective label in the first set of labels; and
replace one or more respective labels included in the first set of labels with an alternate label for the one or respective labels in the dictionary to generate the plurality of synthetic transactions.

14. The system of claim 13, wherein the one or more alternate labels for each respective label in the first set of labels comprises one or more synonyms of the respective label.

15. The system of claim 13, wherein the one or more alternate labels for each respective label in the first set of labels comprise a label for each respective label on a different webpage than the webpage from which the sample data is obtained.

16. The system of claim 13, wherein to replace the one or more respective labels included in the first set of labels with the alternate label for the one or more respective labels in the dictionary, the computer executable instructions cause the system to randomly replace the one or more respective labels included in the first set of labels with the alternate label for the one or more respective labels in the dictionary.

17. The system of claim 13, wherein:
the first attribute of one or more of the plurality of live transactions has a monetary format; and
to generate the training data, the computer executable instructions cause the system to add an operand for the first attribute of one or more of the synthetic transactions.

18. The system of claim 12, further comprising:
subsequent to training the machine learning model using the training data, the computer executable instructions further cause the system to fine-tune the trained machine learning model based on using the trained machine learning model to automatically extract transactions from a webpage other than the webpage from which the sample data is obtained.

19. The system of claim 12, wherein the machine learning model comprises a named entity recognition model.

20. The system of claim 12, wherein the webpage comprises a hypertext markup language (HTML) webpage.
